(19) United States
(12) Patent Application Publication
(10) Pub. No.: US 2016/0163250 A1
(43) Pub. Date: Jun. 9, 2016

(54) DISPLAY CONTROLLER AND IMAGE PROCESSING METHOD

(71) Applicant: SAMSUNG DISPLAY CO., LTD., YONGIN-SI (KR)

(72) Inventors: HIROSHI OHISHI, YOKOHAMA (JP); MASAHIKO YOSHIYAMA, YOKOHAMA (JP); TAKASHI YASUOKA, YOKOHAMA (JP)

(21) Appl. No.: 14/957,217

(22) Filed: Dec. 2, 2015

(30) Foreign Application Priority Data
Dec. 4, 2014 (JP) 2014-246068

(51) Int. Cl. G09G 3/20; G09G 3/32

(52) U.S. Cl. CPC G09G 3/2003; G09G 3/3208; G09G 2320/066; G09G 2320/0626; G09G 2320/0666; G09G 2320/0673

(57) ABSTRACT

An image processing device includes a contrast adjusting unit that calculates an illumination light based on a brightness value of an input image signal, adjusts brightness of the illumination light, and generates a new brightness value, a color emphasis unit that calculates an illumination light based on a color value of the input image signal, adjusts brightness of the illumination light, and generates a new color value, and an output image signal generating unit that generates an output image signal for displaying an image on a transparent display device from the new brightness value and new color value.

### CROSS-REFERENCE TO RELATED APPLICATIONS

This U.S. non-provisional patent application claims priority under 35 U.S.C. §119 from, and the benefit of, Japanese Patent Application No. JP2014-246068, filed on Dec. 4, 2014, the contents of which are herein incorporated by reference in their entirety.

### BACKGROUND

Embodiments of the present disclosure herein are directed to an image processing device, an image processing method, and a display device.

A transparent display device through which a background of a screen is translucently visible may be applied to a building, a window of a vehicle, or a show-window of a shop, etc. A transparent display device may perform a function such as advertisement, or information provision. In addition, a transparent display device has attracted attention as a future display device due to its design features.

Due to having a translucently visible background, a transparent display device has a low image visibility. However, conventional methods of enhancing image visibility may introduce undesirable background effects or may require additional display components, such as a filter, which can increase manufacturing complexity and cost

### SUMMARY

Embodiments of the present disclosure can provide an image processing device, image processing method and display device for improving visibility of an image displayed on a transparent display device by adjusting the image and without increasing manufacturing cost of the transparent display device.

Embodiments of the inventive concept provide display controllers for a transparent display device. The display controller includes: a contrast adjustment unit that calculates a second estimated illumination light from a first estimated illumination light estimated based on a brightness value of an input image signal, wherein the second estimated illumination light is brighter than the first estimated illumination light by a predetermined amount when the brightness of the first estimated illumination light is equal to or less than predetermined brightness, and that generates a new brightness value based on the first and second estimated illumination lights lights and the brightness value of the input image signal; a color emphasis unit that calculates a fourth estimated illumination light from a third estimated illumination light estimated based on a color value of the input image signal, wherein the fourth estimated illumination light is brighter than the third estimated illumination light by a predetermined amount when the lightness of the third estimated illumination light is equal to or less than a predetermined brightness, and that generates a new color value based on the third and fourth estimated illumination lights, the color value and a chroma value extracted from the input image signal; and an output image signal generating unit that generates an output image signal for displaying an image on the transparent display device from the new brightness value and new color value.

In some embodiments, the color emphasis unit may include: an illumination light estimating unit that executes a vignetting process on the color value of the input image signal to estimate the third estimated illumination light; an adjustment unit that adjusts brightness of the third estimated illumination light to calculate the fourth estimated illumination light; and a reflectivity estimating unit that estimates the reflectivity based on the color value of the input image signal, and the third and fourth estimated illumination lights, wherein the reflectivity is used to generate the new color value.

In other embodiments, the reflectivity estimating unit may adjust a chroma of the fourth illumination light.

In still other embodiments, the reflectivity estimating unit may adjust a chroma differently according to whether or not the chroma of the fourth illumination light is less than a predetermined threshold value.

In even other embodiments, the illumination light estimating unit may estimate the third estimated illumination light by using a Gaussian filter.

In some embodiments, the contrast adjustment unit may include an illumination light estimating unit that executes a vignetting process on the brightness value of the input image signal to estimate the first estimated illumination light; an adjustment unit that that adjusts brightness of the first estimated illumination light to calculate the second estimated illumination light; and a reflectivity estimating unit that generates the new brightness value based on the first and second estimated illumination lights and the brightness value of the input image signal.

In other embodiments, the display controller may include a color space conversion unit that converts the input image signal into the brightness value and the color value based on a CIELAB color space.

Further embodiments of the inventive concept provide methods for processing an image to be displayed on a transparent display device. The image processing method includes: adjusting a contrast of a first estimated illumination light estimated based on a brightness value of an input image signal to calculate a second estimated illumination light, wherein the second estimated illumination light is brighter than the first estimated illumination light by a predetermined amount when the brightness of the first estimated illumination light is equal to or less than a predetermined brightness, generating a new brightness value based on the first and second estimated illumination lights and the brightness value of the input image signal; emphasizing color of a third estimated illumination light estimated based on a color value of the input image signal to calculate a fourth estimated illumination light, wherein the fourth estimated illumination light is brighter than the third estimated illumination light by a predetermined amount when the brightness of the third estimated illumination light is equal to or less than predetermined brightness, generating a new color value based on the third and fourth estimated illumination lights, the color value and a chroma value extracted from the input image signal; and generating an output image signal for displaying an image on the transparent display device from the new brightness value and new color value.

In some embodiments, emphasizing color of the third estimated illumination light may include executing a vignetting process on the color value of the input image signal to estimate the third estimated illumination light; adjusting a brightness of the third estimated illumination light to calculate the fourth estimated illumination light; and estimating a reflectivity based on the color value of the input image signal, and the third and fourth estimated illumination lights, wherein the reflectivity is used to generate the new color value.

In other embodiments, the methods may include adjusting a chroma of the fourth illumination light, wherein the chroma is adjusted differently based on whether or not the chroma is less than a predetermined threshold value.

In still other embodiments, adjusting the contrast of the first estimated illumination light may include executing a vignetting process on the brightness value of the input image signal to estimate the first estimated illumination light; adjusting brightness of the first estimated illumination light to calculate the second estimated illumination light; and generating the new brightness value based on the first and second estimated illumination lights and the brightness value of the input image signal.

Further embodiments of the inventive concept provide display controllers for a transparent display device. The display controller includes a color emphasis unit that calculates calculating a fourth estimated illumination light from a third estimated illumination light estimated based on a color value of the input image signal, wherein the fourth estimated illumination light is brighter than the third estimated illumination light by a predetermined amount when the brightness of the third estimated illumination light is equal to or less than predetermined lightness, and that generates a new color value based on the third and fourth estimated illumination lights, the color value and a chroma value extracted from the input image signal. The color emphasis unit includes an illumination light estimating unit that executes a vignetting process on the color value of the input image signal to estimate the third estimated illumination light; an adjustment unit that adjusts brightness of the third estimated illumination light to calculate the fourth estimated illumination light; and a reflectivity estimating unit that estimates a reflectivity based on the color value of the input image signal, and the third and fourth estimated illumination lights, wherein the reflectivity is used to generate the new color value.

In some embodiments, the reflectivity estimating unit may adjust a chroma of the fourth illumination light.

In some embodiments, the reflectivity estimating unit may adjust the chroma differently based on whether or not the chroma is less than a predetermined threshold value.

In some embodiments, the illumination light estimating unit may estimate the third estimated illumination light by using a Gaussian filter.

In some embodiments, the display controller may further include a color space conversion unit that converts the input image signal into the brightness value and the color value based on a CIELAB color space; a contrast adjustment unit that calculates a second estimated illumination light estimated based on a brightness value of an input image signal, wherein the second estimated illumination light is brighter than the first estimated illumination light by a predetermined amount when the brightness of the first estimated illumination light is equal to or less than a predetermined brightness, and that generates a new brightness value based on the first and second estimated illumination lights and the brightness value of the input image signal; and an output image signal generating unit that generates an output image signal for displaying an image on the transparent display device from the new brightness value and the new color value.

In other embodiments the contrast adjustment unit may include an illumination light estimating unit that executes a vignetting process on the brightness value of the input image signal to estimate the first estimated illumination light; an adjustment unit that that adjusts brightness of the first estimated illumination light to calculate the second estimated illumination light; and a reflectivity estimating unit that generates the new brightness value based on the first and second estimated illumination lights and the brightness value of the input image signal.

### BRIEF DESCRIPTION OF THE DRAWINGS

FIG. 1 is a block diagram of a configuration of a display device according to an embodiment of the present inventive concept.

FIG. 2 is a block diagram of a configuration of a display controller.

FIG. 3 is a block diagram of a configuration of a color space conversion preprocessing unit.

FIG. 4 is a block diagram of a configuration of a contrast adjusting unit.

FIG. 5 is a block diagram of a configuration of a color emphasis unit.

FIG. 6 illustrates an exemplary table used by an adjusting unit for an adjustment process.

FIG. 7 is a block diagram of a configuration of a color space conversion post-processing unit.

FIG. 8 is a flowchart of an exemplary operation of a display device according to an embodiment of the present inventive concept.

### DETAILED DESCRIPTION OF EXEMPLARY EMBODIMENTS

Exemplary embodiments of the inventive concept will be described below in more detail with reference to the accompanying drawings. Throughout the specification and drawings, like reference numerals may refer to elements having like function configurations to omit overlapping description.

Hereinafter, exemplary embodiments of the inventive concept will be described in detail with reference to the accompanying drawings.

A background of an embodiment of the present inventive concept will be described and then the embodiment of the present inventive concept will be described.

As described above, a transparent display device attracts attention by being transmissive and having a translucently visible background. A transparent display device may be an self-emissive organic electroluminescent display device in which a pixel autonomously emits light without a separate backlight. In a transparent display device, a background of a rear surface of a display device may be visible in a non-display state by using transparent electrodes in the organic electroluminescent display device.

A transparent display device does not display black since background light is transmitted without being blocked. Accordingly, when an image is displayed on a transparent display device, the background is transmitted through a dark portion to allow the image and background to be visibly overlapped.

Herein, exemplary embodiments can provide a transparent display device that can display a natural image with a undesirable background effects. As will be described below, a process is executed to adjust the quality of an image displayed on a transparent display device so that the image affected by the background does not overlap the background. Accordingly, embodiments of the disclosure can provide a transparent display device which does not require a filter to control the transmissivity and can display a natural image by suppressing background effects.

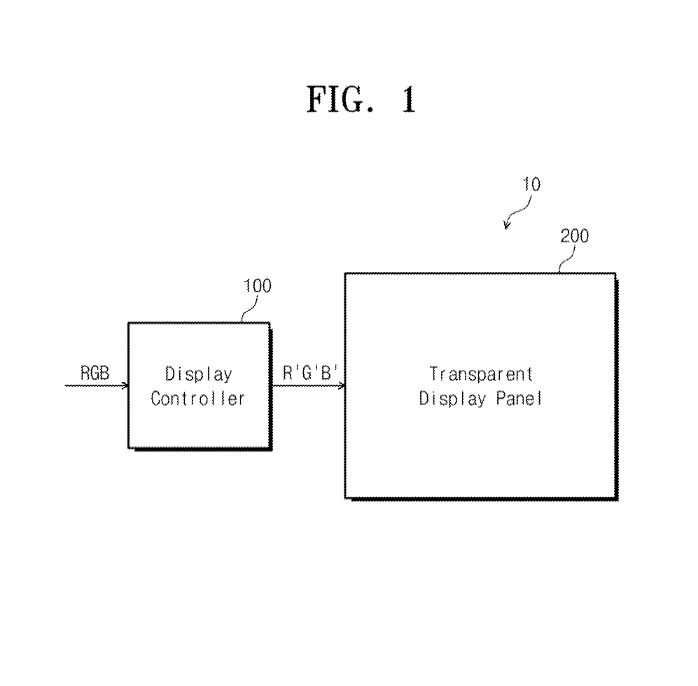

Next is described a display according to an exemplary embodiment of the present inventive concept. FIG. 1 is a block diagram of a configuration of a display device according to an embodiment of the present inventive concept.

As shown in FIG. 1, a display device 10 according to an embodiment of the present inventive concept includes a display controller 100 and a transparent display panel 200.

The display controller 100 executes a process for displaying an image for an input image signal RGB on the transparent display panel 200. Although various signals may be considered as the input image signal RGB, according to exemplary embodiments, an input image signal RGB for displaying, for example, a predetermined figure, character, photo, or other information will be assumed.

In an embodiment of the present inventive concept, the display controller 100 executes an adjustment process for an image to be displayed on the transparent display panel 200, which is one of processes for displaying an image on the transparent display panel 200. The display controller 100 generates an output image signal R′G′B′ on the basis of the input image signal RGB and outputs the output image signal R′G′B′ to the transparent display panel 200.

The transparent display panel 200 is a display device through which a background of a screen is translucently visible. The display device 10 may include, but is not limited to, an organic light emitting device. In this case, the organic light emitting device is arranged in a matrix form and each electrode of the organic light emitting device is a transparent electrode. The transparent display panel 200 displays an image on the basis of the output image signal R′G′B′ received from the display controller 100.

In a present embodiment, the transparent display panel 200 displays an image based on the output image signal R′G′B′ received from the display controller 100. Background image effects of the transparent display panel 200 may be suppressed to improve visibility of the display device 10 by performing by the display controller 100 an adjustment process on the image to be displayed.

Next, a description is provided of an exemplary configuration of the display controller 100 according to an embodiment of the present inventive concept.

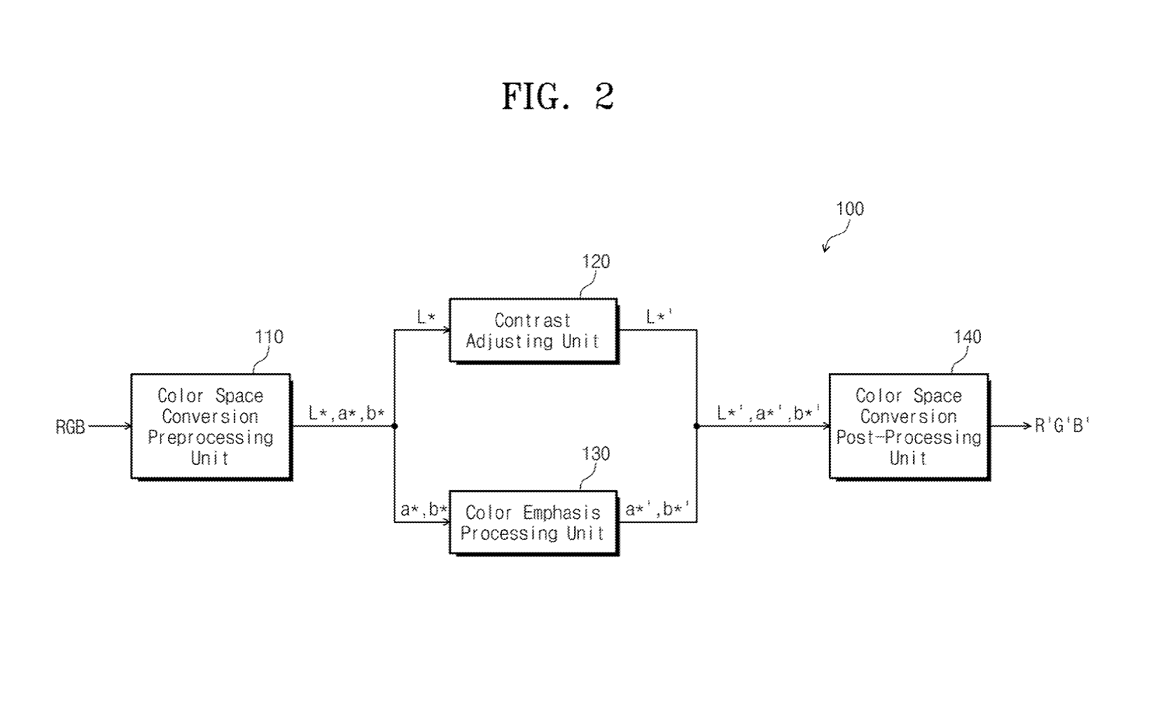

FIG. 2 is a block diagram of a configuration of a display controller. FIG. 2 shows an exemplary configuration of the display controller 100 for executing an adjustment process on the image to be displayed on the transparent display panel 200 of FIG. 1.

As shown in FIG. 2, the display controller 100 includes a color space conversion preprocessing unit 110, a contrast adjusting unit 120, a color emphasis processing unit 130, and a color space conversion post-processing unit 140.

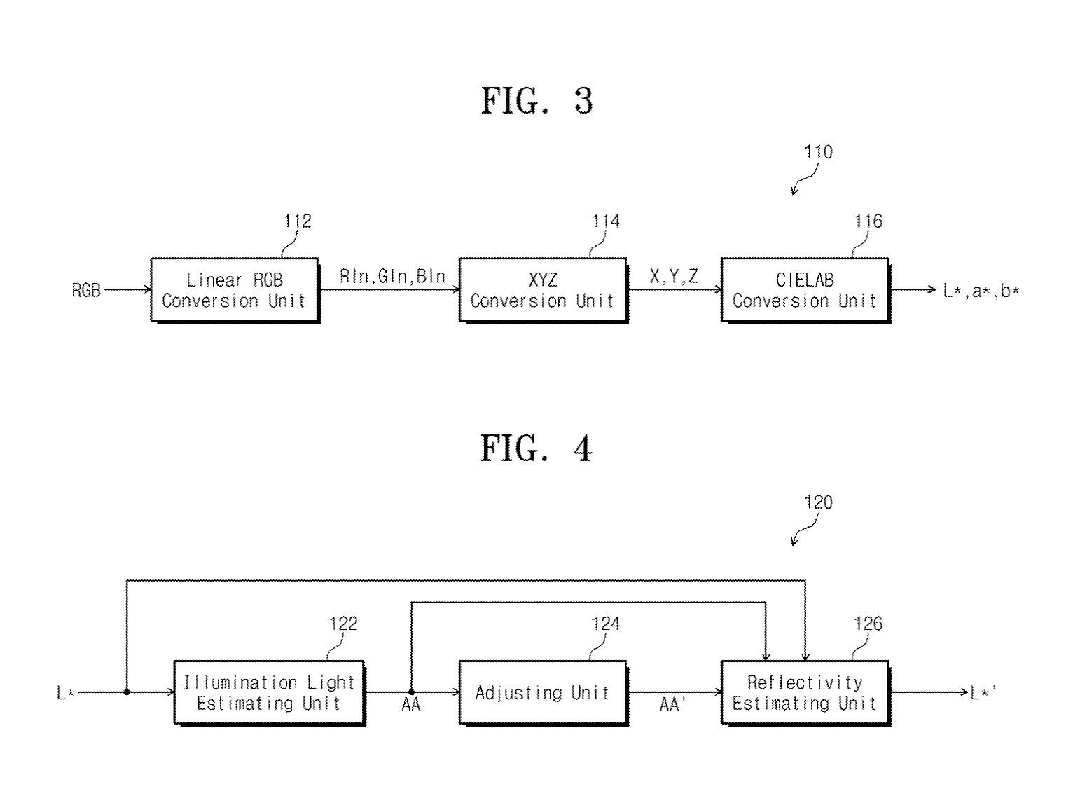

The color space conversion preprocessing unit 110 can convert the input image signal RGB received by the display controller 100 into data based on a CIELAB color space. The color space conversion preprocessing unit 110 executes a process that can convert an RBG color space into the CIELAB color space. The color space conversion preprocessing unit 110 outputs a brightness value L*, and color values a* and b* on the basis of the input image signal RGB. The color space conversion preprocessing unit 110 outputs the brightness value L* to the contrast adjusting unit 120 and the color values a* and b* to the color emphasis processing unit 130. A detailed description of an exemplary configuration of the color space conversion preprocessing unit 110 is provided with reference to FIG. 3.

The contrast adjusting unit 120 executes a contrast adjustment process that can convert the brightness value L* into a brightness value L*′ suitable for display on a transparent display panel 200 of FIG. 1. The contrast adjusting unit 120 transmits the brightness value L*′ suitable for a display on the transparent display panel 200 to the color space conversion post-processing unit 140. A detailed description of an exemplary configuration of the contrast adjusting unit 120 is provided with reference to FIG. 4.

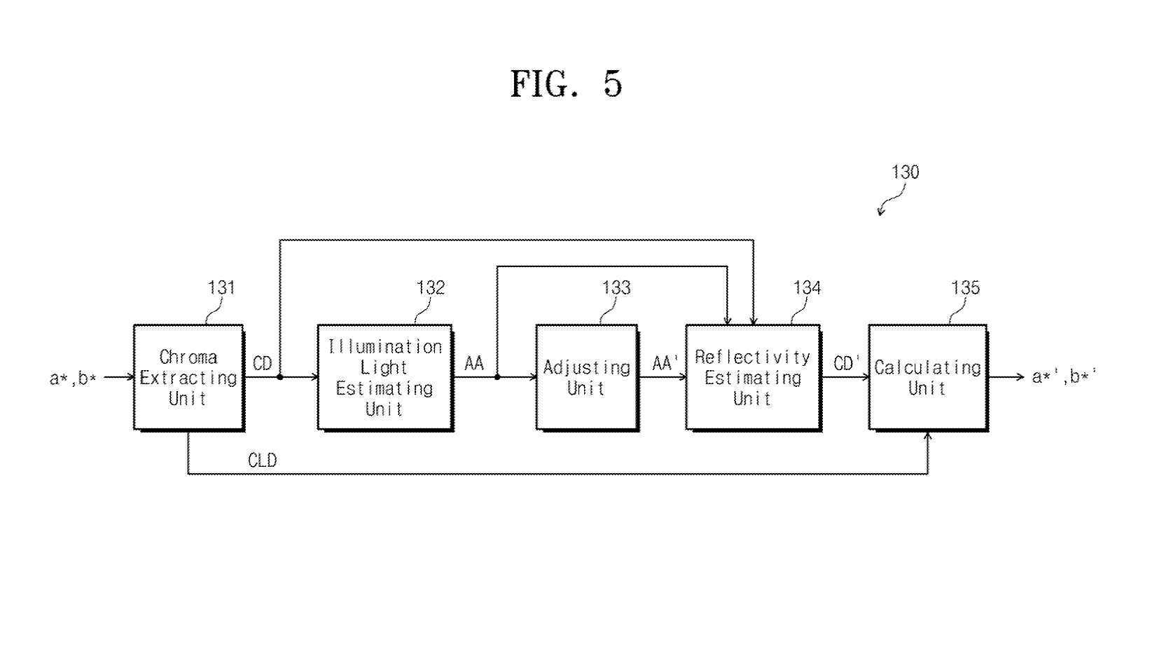

The color emphasis processing unit 130 executes a color emphasis process that can convert the color values a* and b* of the input image received from the color space conversion preprocessing unit 110 into color values a*′ and b*′ suitable for display on the transparent display panel 200. The color emphasis processing unit 130 transmits the color values a*′ and b*′ suitable for display on the transparent display panel 200 to the color space conversion post-processing unit 140. A detailed description of an exemplary configuration of the color emphasis processing unit 130 is provided with reference to FIG. 5.

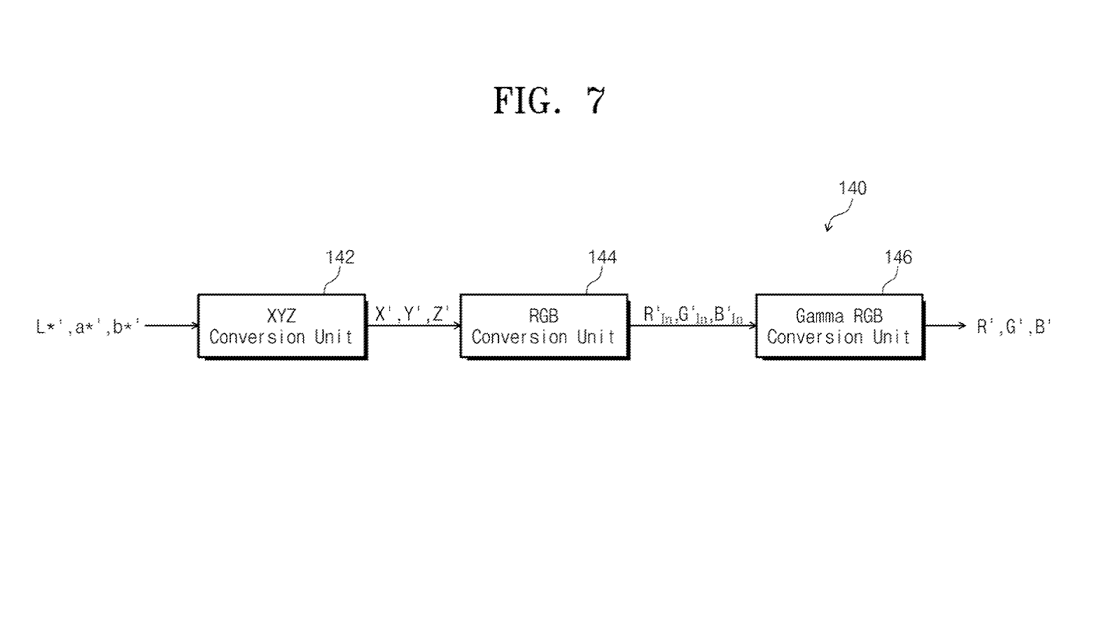

The color space conversion post-processing unit 140 executes a process that can convert a color space from the CIELAB color space into the RGB color space. The color space conversion post-processing 140 may be called an output image signal generating unit. In detail, the color space conversion post-processing unit 140 executes a process that converts the color space from a CIELAB color space into an RGB color space by using the brightness value L*′ received from the contrast adjusting unit 120 and color values a*′ and b*′ received from the color emphasis processing unit 130. A detailed description of an exemplary configuration of the color space conversion post-processing unit 140 is provided with reference to FIG. 7.

The display controller 100 according to an embodiment of the present inventive concept with a configuration as shown in FIG. can generate an output image signal R′G′B′ obtained from an adjustment process performed on the image to be displayed on the transparent display panel 200.

Next, a description is provided of an exemplary configuration of each unit of the display controller 100 shown in FIG. 2.

FIG. 3 is a block diagram showing an exemplary function configuration of the color space conversion preprocessing unit 110 that can execute a process that converts the input image signal RGB from the RGB color space into a signal of the CIELAB color space. Hereinafter, an exemplary function configuration of the color space conversion preprocessing unit 110 will be described with reference to FIG. 3.

As shown in FIG. 3, the color space conversion preprocessing unit 110 includes a linear RGB conversion unit 112, an XYZ conversion unit 114, and a CIELAB conversion unit 116.

The linear RGB conversion unit 112 obtains linear RGB values Rln, Gln, and Bln from the red, green, and blue data of the image signal RGB. In detail, the linear RGB conversion unit 112 raises each value of the red, green, and blue data to the 2.2 power (each value of the red, green, and blue data^{2.2}) to calculate the linear RGB values Rln, Gln, and Bln. The linear RGB conversion unit 112 outputs the linear RGB values Rln, Gln, and Bin to the XYZ conversion unit 114.

The XYZ conversion unit 114 obtains XYZ values X, Y, and Z based on the linear RGB values Rln, Gln, and Bln. In detail, the XYZ conversion unit 114 obtains XYZ values X, Y, and Z by using an XYZ conversion matrix M that corresponds to an input image color gamut for the linear RGB values Rln, Gln, and Bln. The XYZ conversion unit 114 converts the linear RGB values Rln, Gln, and Bln into XYZ values X, Y, and Z according to the following Equation (1).

[X, Y, Z]^{T}=M×[Rln, Gln, Bln]^{T} [Equation 1]

In Equation (1), M denotes a 3×3 conversion matrix corresponding to an input image color gamut. In addition, the XYZ conversion unit 114 outputs the XYZ values X, Y, and Z to the CIELAB conversion unit 116.

The CIELAB conversion unit 116 converts the XYZ values X, Y, and Z received from the XYZ conversion unit 114 into the CIELAB values L*, a*, and b*. In detail, the CIELAB conversion unit 116 converts the XYZ values X, Y, and Z received from the XYZ conversion unit 114 into the CIELAB values L*, a*, and b* according to the following Equation (2).

$${L}^{*} = 116 f ( Y / {Y}_{n} ) - 16 \\ {a}^{*} = 500 [ f ( X / {X}_{n} ) - f ( Y / {Y}_{n} ) ] \\ {b}^{*} = 200 [ f ( Y / {Y}_{n} ) - f ( Z / {Z}_{n} ) ] \\ f ( t ) = \{ \begin{matrix}{t}^{1 / 3} & t > {( 6 / 29 )}^{3} \\ \frac{1}{3} {( \frac{29}{6} )}^{2} t + \frac{4}{29} & otherwise\end{matrix} \qquad [ Equation 2 ]$$

In Equation (2), (Xn, Yn, Zn) denotes a white point. Note that the brightness value L* is normalized from 0.0 to 1.0.

Next, an exemplary function configuration of the contrast adjusting unit 120 will be provided.

FIG. 4 is a block diagram of a configuration of a contrast adjusting unit. The contrast adjusting unit 120 converts the brightness L* received from the color space conversion preprocessing unit 110 of FIG. 3 into a brightness value L*′ suitable for display on the transparent display panel 200. In a present embodiment, the contrast adjusting unit 120 executes a contrast adjustment process that applies Retinex theory.

The contrast adjusting unit 120 includes an illumination light estimating unit 122, an adjusting unit 124, and a reflectivity estimating unit 126.

The illumination light estimating unit 122 executes a process that estimates illumination light for the brightness value L*. In detail, the illumination light estimating unit 122 executes a vignetting process with a filter, such as a Gaussian filter, for the brightness value L* to calculate a first estimated illumination light data AA. The first estimated illumination light data AA includes information about a first estimated illumination light. The illumination light estimating unit 122 sends the calculated first estimated illumination light data AA to the adjusting unit 124 and reflectivity estimating unit 126. The first estimated illumination light data AA includes a value calculated by the following equation (3).

A0=N(σ=7)*(L*)

A1=N(σ=5)*(L*)

A2=N(σ=3)*(L*)

AA=(A0+A1+A2+(L*))/4 [Equation 3]

In Equation (3), N(σ) denotes a Gaussian kernel, and * denotes convolution. Retinex theory normally uses a very large kernel to obtain an effect thereof. However, in a present embodiment, a small Gaussian kernel of about 7×7 is used due to hardware considerations.

The illumination light estimating unit 122 may employ a multi-scale retinex that uses a Gaussian filter that has a plurality of kernel sizes. The illumination light estimating unit 122 can reduce a halo effect by employing a multi-scale retinex.

Furthermore, the illumination light estimating unit 122 can perform a vignetting process, such as box filtering, while calculating the first estimated illumination light data AA.

The adjusting unit 124 executes an adjustment process on the first estimated illumination light data AA received from the illumination light estimating unit 122. As described above, in a present embodiment, a contrast ratio may be lowered by using a small Gaussian kernel of about 7×7 when calculating the first estimated illumination light data AA. Accordingly, the adjusting unit 124 performs an adjustment to increase a dark portion.

The adjusting unit 124 may improve a contrast by performing the adjustment to increase the dark portion, even when a small Gaussian kernel is used. The adjusting unit 124 sends to the reflectivity estimating unit 126 second estimated illumination data AA′ obtained by adjusting the first estimated illumination light data AA. The second estimated illumination light data AA′ includes information about a second estimated illumination light.

The reflectivity estimating unit 126 calculates the brightness value L*′ by using the first estimated illumination light data AA calculated by the illumination light estimating unit 122 and the second estimated illumination light data AA′ adjusted by the adjusting unit 124. This brightness value L*′ is suitable for display on the transparent display panel 200. The reflectivity estimating unit 126 calculates the brightness value L*′ by using the following Equation (4).

L*′=AA′(L*/AA) [Equation 4]

Next, an exemplary function configuration of the color emphasis processing unit 130 will be described.

FIG. 5 is a block diagram of an exemplary function configuration of a color emphasis processing unit 130 that can execute a color emphasis process that converts the color values a* and b* of the input image received from the color space conversion preprocessing unit 110 of FIG. 3 into color values a*′ and b*′ suitable for display on the transparent display panel 200. In a present embodiment, the color emphasis processing unit 130, like the contrast adjusting unit 120, executes a color emphasis process that applies retinex theory. Hereinafter, an exemplary function configuration of the display controller 130 will be described with reference to FIG. 5.

The color emphasis processing unit 130 includes a chroma extracting unit 131, an illumination light estimating unit 132, an adjusting unit 133, a reflectivity estimating unit 134, and a calculating unit 135.

The chroma extracting unit 131 calculates chroma data CD and color data CLD for the color values a* and b*. The chroma extracting unit 131 calculates chroma data CD and color data CLD corresponding to the color values a* and b* according to the following Equation (5).

CD=\sqrt{a*²+b}*²

CLD=arctan(b*/a*) Equation [5]

In addition, the chroma data CD is normalized from 0.0 to 1.0. When extracting the chroma data CD and color data CLD for the color values a* and b* of the input image, the chroma extracting unit 131 sends the calculated chroma data CD to the illumination light estimating unit 132 and reflectivity estimating unit 134, and the calculated color data CLD to the calculating unit 135.

The illumination light estimating unit 132 performs a same process as that of the illumination light estimating unit 122 shown in FIG. 4. In other words, the illumination light estimating unit 132 estimates the illumination light for the chroma data CD of the input image, which is received from the chroma extracting unit 131. In detail, the illumination light estimating unit 132 executes a vignetting process, such as Gaussian filtering, for the chroma data CD to calculate third estimated illumination light data AA. The third estimated illumination light data AA includes information about a third estimated illumination light. The illumination light estimating unit 132 sends the third estimated illumination light data AA to the adjusting unit 133 and the reflectivity estimating unit 134. The third estimated illumination light data AA is calculated according to Equation (3), above.

Furthermore, the illumination light estimating unit 132 performs a vignetting process, such as box filtering, as part of the calculation of the third estimated illumination light data AA.

The adjusting unit 133 performs the same process as that of the adjusting unit 124 shown in FIG. 4. In other words, the adjusting unit 133 adjusts the third estimated illumination light data AA calculated by the illumination light estimating unit 132. As described above, in a present embodiment, when using a small Gaussian kernel of about 7×7 to calculate the third estimated illumination light AA, an adjustment process is executed by the adjusting unit 133 to increase a dark portion to prevent the contrast ratio from being lowered. Accordingly, even when a small Gaussian kernel is used, a contrast can be improved. The adjusting unit 133 calculates a fourth estimated illumination data AA′ by executing the adjustment process for the third estimated illumination light data AA. The fourth estimated illumination light data AA′ includes information about a fourth estimated illumination light.

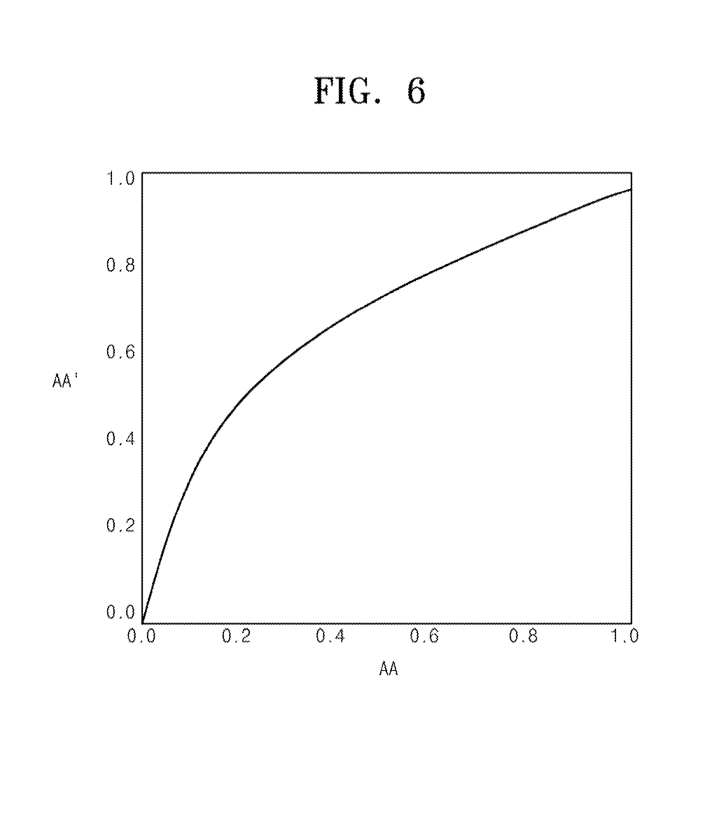

FIG. 6 illustrates an exemplary table used by an adjusting unit for an adjustment process. FIG. 6 is a graph representing the second and forth estimated illumination light data AA′ as a function of the first and third estimated illumination light data AA. The adjusting unit 133 uses a table represented by the graph shown as FIG. 6 to execute an adjustment process to increase the first and third estimated illumination light data AA for dark portions. Note that the first and third estimated illumination light data AA and the second and forth estimated illumination light data AA′ are normalized from 0.0 to 1.0.

The reflectivity estimating unit 134 performs the same process as that of the reflectivity estimating unit 126 shown in FIG. 4. In other words, the reflectivity estimating unit 134 receives the chroma data CD, the third estimated illumination light AA and fourth estimated illumination light AA′. The reflectivity estimating unit 134 calculates chroma data CD′ based on the chroma data CD, the third illumination light AA and the fourth illumination light AA′. This chroma data CD′ is a brightness value suitable fordisplay on the transparent display panel 200 of FIG. 1. The reflectivity estimating unit 134 outputs the chroma data CD′ to the calculating unit 135. The reflectivity estimating unit 134 calculates the chroma data CD′ by using the following Equation (6).

CD′=(1.0−(CD/Th)²)+CD″(CD/Th)², CD<Th

CD′=CD″, CD≧Th

CD″=AA′(CD/AA) [Equation 6]

Th is a predetermined threshold value and may be about 0.3. Referring to Equation (6), methods of calculating the chroma data CD′ differ according to the threshold value Th. The reason is that when an emphasis process is executed for values near an L-axis (a brightness axis), a color close to original gray may become tinged with an unnatural color, thus an emphasis process is not executed for values near an L* axis.

The calculating unit 135 calculates color values a*′ and b*′ suitable for display on the transparent display panel 200 by using the chroma data CD′ calculated by the reflectivity estimating unit 134 and the color data CLD calculated by the chroma extracting unit 131. The calculating unit 135 calculates the color values a*′ and b*′ by using the following Equation (7).

a*′=CD′×cos(CLD)

b*′=CD′×sin(CLD) [Equation 7]

Next, an exemplary function configuration of the color space conversion post-processing unit 140 will be described.

FIG. 7 is a block diagram of a configuration of a color space conversion post-processing unit 140. In detail, the color space conversion post-processing unit 140 executes a process that converts a color space from the CIELAB color space into the RGB color space by using the brightness value L*′ output from the contrast adjusting unit 120 of FIGS. 2 and 4 and the color values a*′ and b*′ output from the color emphasis processing unit 130 of FIGS. 2 and 5. Hereinafter, an exemplary function configuration of the color space conversion post-processing unit 140 will be described with reference to FIG. 7.

The color space conversion post-processing unit 140 includes an XYZ conversion unit 142, an RGB conversion unit 144, and a gamma RGB conversion unit 146.

The XYZ conversion unit 142 converts the brightness value L*′ and the color values a*′ and b*′ into XYZ values X′, Y′, and Z′ by using the following Equation (8). The XYZ conversion unit 142 sends the converted XYZ values X′, Y′, and Z′ to the RGB conversion unit 144.

$$\begin{matrix}X = f ( {X}_{n} , x ) \\ Y = f ( {Y}_{n} , y ) \\ Z = f ( {Z}_{n} , z ) \\ f ( {T}_{n} , t ) = \{ \begin{matrix}{T}_{n} {t}^{3} , t > \frac{6}{29} \\ 3 {T}_{n} ( t - \frac{16}{116} ) {( \frac{6}{29} )}^{2} , otherwise\end{matrix} \\ y = \frac{{L}^{*} + 16}{116} \\ x = y + \frac{{a}^{*}}{500} \\ z = y - \frac{{b}^{*}}{200}\end{matrix} \vert \qquad [ Equation 8 ]$$

In Equation (8), (Xn, Yn, Zn) denotes a white point. The RGB conversion unit 144 executes a process that converts the XYZ values X′, Y′, and Z′ into RGB values R′ₗₙ, G′ₗₙ and B′ₗₙ by using the following Equation (9). The RGB conversion unit 144 outputs the converted RGB values R′ₗₙ, G′ₗₙ and B′ₗₙ to the gamma RGB conversion unit 146.

[R′ₗₙ, G′ₗₙ , B′ₗₙ]^{T}=N⁽⁻¹⁾×[X′, Y′, Z′]^{T} [Equation 9]

In Equation (9), N denotes a 3×3 conversion matrix that corresponds to a color gamut of the transparent display panel 200.

The gamma RGB conversion unit 146 executes a process that converts the RGB values R′ₗₙ, G′ₗₙ and B′ₗₙ into gamma RGB values R′, G′, and B′ by using the following Equation (10). The output image signal R′G′B′ sent to the transparent display panel 200 of FIG. 1 includes the gamma RGB values R′, G′, and B′.

R′=R′ₗₙ^{(1.0/2.2)}

G′=G′ₗₙ^{(1.0/2.2)}

B′=B′ₗₙ^{(1.0/2.2)} [Equation 10]

The display controller 100 with the above-described configuration included in the display device 10 of FIG. 1 according to an embodiment of the present inventive concept may generate an image signal by executing an adjustment process on an image to be displayed on the transparent display panel 200 of FIG. 1. In other words, the display controller 100 of FIG. 1 according to an embodiment of the present inventive concept can generate an image suitable for display on the transparent display panel 200 of FIG. 1 by improving contrast with the contrast adjusting unit 120 of FIG. 2 and by performing a color emphasis process in the color emphasis processing unit 130 of FIG. 2.

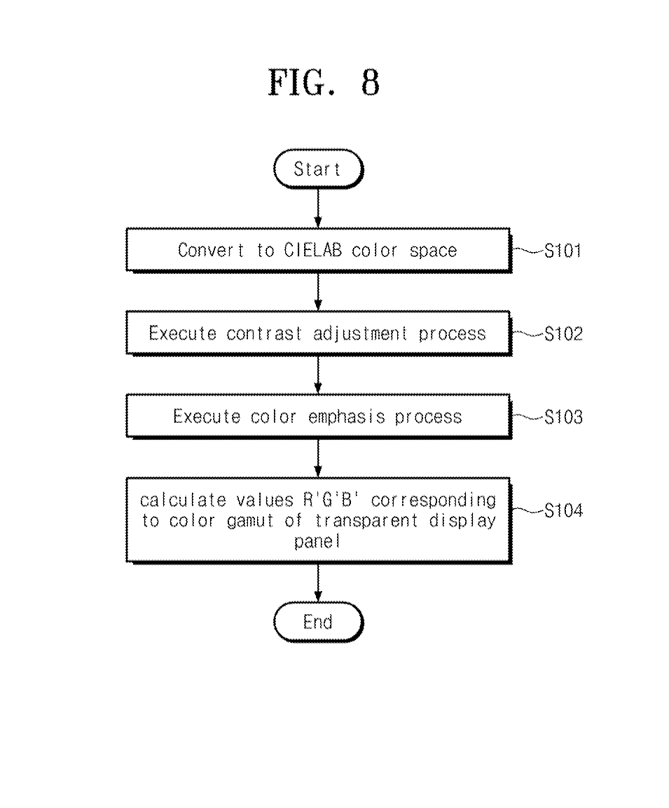

Next, a description is provided of an exemplary operation of display controller 100 of the display device 10 of FIG. 1 according to an embodiment of the present inventive concept. FIG. 8 is a flowchart of an exemplary operation of the display controller 100 of a display device 10 of FIG. 1 according to an embodiment of the present inventive concept for executing an adjustment process on an image to be displayed on the transparent display panel 200 of FIG. 1. Hereinafter, description is provided of an exemplary operation of a display device 10 of FIG. 1 according to an embodiment of the present inventive concept with reference to FIG. 8.

The color space conversion preprocessing unit 110 of FIG. 2 in the display controller 100 of FIG. 1 executes a process that converts a color space for the input image signal from an RGB color space into a CIELAB color space (operation S101). The color space conversion process from the RGB color space to the CIELAB color space by the color space conversion preprocessing unit 110 of FIG. 2 is the same as that described above and accordingly a repeated detailed description thereof will be omitted.

The contrast adjusting unit 120 of FIG. 2 performs a contrast adjustment process (operation S102). The color emphasis processing unit 130 of FIG. 2 performs a color emphasis process (operation S103). The contrast adjustment process operation S102 and the color emphasis process operation S103 may be performed in a reversed order or simultaneously.

Methods of adjusting contrast S102 by the contrast adjusting unit 120 of FIGS. 4 and 2 and of emphasizing color S103 by the color emphasis processing unit 130 of FIGS. 5 and 2 are the same as those described above, and a repeated detailed descriptions thereof will be omitted.

The color space conversion post-processing unit 140 of FIGS. 7 and 2 executes a process for calculating RGB values that correspond to a color gamut of the transparent display panel 200 of FIG. 1 (operation S104). In detail, a process for converting a color space from the CIELAB color space into the RGB color space uses the brightness value L*′ of FIG. 4 generated in the contrast adjustment process operation S102 and the color values a*′ and b*′ of FIG. 5 generated in the color emphasis process operation S103. Since the RGB value calculating operation S104 is the same as that described above, a repeated detailed description thereof will be omitted herein.

The display controller 100 of FIG. 1 according to an embodiment of the present inventive concept may perform an adjustment process on an image to be displayed on the transparent display panel 200 of FIG. 1 by executing the operation described above.

As described above, according to an embodiment of the present inventive concept, the display controller 100 of FIG. 1 generates the output image signal R′G′B′ of FIG. 1 on which the adjustment process was performed and the transparent display panel 200 of FIG. 1 displays an image based on the output image signal R′G′B′ of FIG. 1.

The display controller 100 of FIG. 1 executes a contrast adjustment process and a color emphasis process on the basis of the input image signal RGB of FIG. 1 and then generates the output image signal R′G′B′ of FIG. 1.

The display controller 100 of FIG. 1 according to an embodiment of the present inventive concept executes a contrast adjustment process and a color emphasis process for a display on the transparent display panel 200 of FIG. 1. Accordingly, visibility of an image displayed on the transparent display panel 200 of FIG. 1 may be improved without increasing a manufacturing cost.

In a process executed by a device herein, the operations are not necessarily executed according to the sequence illustrated in a flowchart or sequence diagram. For example, the operations of a process may be executed in a sequence different from that illustrated in the flowchart or may be executed in parallel.

In addition, a computer program may also achieve the same function as a hardware configuration of each device, with a central processing unit (CPU), read only memory (ROM) and random access memory (RAM) embedded in the device. In addition, it is possible to provide a recording medium on which the computer program is recorded. In addition, a sequence of processes of a function block may be implemented in hardware.

According to a present inventive concept as described above, visibility of an image displayed on a transparent display device can be improved without increasing a manufacturing cost of the transparent display device by adjusting the image.

The above-disclosed subject matter is to be considered illustrative and not restrictive, and the appended claims are intended to cover all such modifications, enhancements, and other embodiments, which fall within the true spirit and scope of the embodiments of the inventive concept. Thus, to the maximum extent allowed by law, the scope of the embodiments of the inventive concept is to be determined by the broadest permissible interpretation of the following claims and their equivalents, and shall not be restricted or limited by the foregoing detailed description.

What is claimed is:

1. A display controller for a transparent display device, the display controller comprising:
a contrast adjustment unit that calculates a second estimated illumination light from a first estimated illumination light estimated based on a brightness value of an input image signal, wherein the second estimated illumination light is brighter than the first estimated illumination light by a predetermined amount when the brightness of the first estimated illumination light is equal to or less than a predetermined brightness, and that generates a new brightness value based on the first and second estimated illumination lights and the brightness value of the input image signal;
a color emphasis unit that calculates calculating a fourth estimated illumination light from a third estimated illumination light estimated based on a color value of the input image signal, wherein the fourth estimated illumination light is brighter than the third estimated illumination light by a predetermined amount when the brightness of the third estimated illumination light is equal to or less than predetermined lightness, and that generates a new color value based on the third and fourth estimated illumination lights, the color value and a chroma value extracted from the input image signal; and
an output image signal generating unit that generates an output image signal for displaying an image on the transparent display device from the new brightness value and the new color value.

2. The display controller of claim 1, wherein the color emphasis unit comprises:
an illumination light estimating unit that executes a vignetting process on the color value of the input image signal to estimate the third estimated illumination light;
an adjustment unit that adjusts brightness of the third estimated illumination light to calculate the fourth estimated illumination light; and
a reflectivity estimating unit that estimates a reflectivity based on the color value of the input image signal, and the third and fourth estimated illumination lights, wherein the reflectivity is used to generate the new color value.

3. The display controller of claim 2, wherein the reflectivity estimating unit adjusts a chroma of the fourth illumination light.

4. The display controller of claim 3, wherein the reflectivity estimating unit adjusts the chroma differently based on whether or not the chroma is less than a predetermined threshold value.

5. The display controller of claim 2, wherein the illumination light estimating unit estimates the third estimated illumination light by using a Gaussian filter.

6. The display controller of claim 1, wherein the contrast adjustment unit comprises:
an illumination light estimating unit that executes a vignetting process on the brightness value of the input image signal to estimate the first estimated illumination light;
an adjustment unit that that adjusts brightness of the first estimated illumination light to calculate the second estimated illumination light; and
a reflectivity estimating unit that generates the new brightness value based on the first and second estimated illumination lights and the brightness value of the input image signal.

7. The display controller of claim 1, further comprising a color space conversion unit that converts the input image signal into the brightness value and the color value based on a CIELAB color space.

8. An method for processing an image to be displayed on a transparent display device, the method comprising:
adjusting a contrast of a first estimated illumination light estimated based on a brightness value of an input image signal to calculate a second estimated illumination light, wherein the second estimated illumination light is brighter than the first estimated illumination light by a predetermined amount when the brightness of the first estimated illumination light is equal to or less than a predetermined brightness;
generating a new brightness value based on the first and second estimated illumination lights and the brightness value of the input image signal;
emphasizing color of a third estimated illumination light estimated based on a color value of the input image signal to calculate a fourth estimated illumination light, wherein the fourth estimated illumination light is brighter than the third estimated illumination light by a predetermined amount when the brightness of the third estimated illumination light is equal to or less than a predetermined brightness;
generating a new color value based on the third and fourth estimated illumination lights, the color value and a chroma value extracted from the input image signal ; and
generating an output image signal for displaying an image on the transparent display device from the new brightness value and the new color value.

9. The method of claim 8, wherein emphasizing color of the third estimated illumination light comprises
executing a vignetting process on the color value of the input image signal to estimate the third estimated illumination light;
adjusting a brightness of the third estimated illumination light to calculate the fourth estimated illumination light; and
estimating a reflectivity based on the color value of the input image signal, and the third and fourth estimated illumination lights, wherein the reflectivity is used to generate the new color value.

10. The method of claim 9, further comprising adjusting a chroma of the fourth illumination light, wherein the chroma is adjusted differently based on whether or not the chroma is less than a predetermined threshold value.

11. The method of claim 8, wherein adjusting the contrast of the first estimated illumination light comprises:
executing a vignetting process on the brightness value of the input image signal to estimate the first estimated illumination light;
adjusting brightness of the first estimated illumination light to calculate the second estimated illumination light; and
generating the new brightness value based on the first and second estimated illumination lights and the brightness value of the input image signal.

12. A display controller for a transparent display device, the display controller comprising:
a color emphasis unit that calculates calculating a fourth estimated illumination light from a third estimated illumination light estimated based on a color value of the input image signal, wherein the fourth estimated illumination light is brighter than the third estimated illumination light by a predetermined amount when the brightness of the third estimated illumination light is equal to or less than predetermined lightness, and that generates a new color value based on the third and fourth estimated illumination lights, the color value and a chroma value extracted from the input image signal, wherein the color emphasis unit comprises:
an illumination light estimating unit that executes a vignetting process on the color value of the input image signal to estimate the third estimated illumination light;
an adjustment unit that adjusts brightness of the third estimated illumination light to calculate the fourth estimated illumination light; and
a reflectivity estimating unit that estimates a reflectivity based on the color value of the input image signal, and the third and fourth estimated illumination lights, wherein the reflectivity is used to generate the new color value.

13. The display controller of claim 12, wherein the reflectivity estimating unit adjusts a chroma of the fourth illumination light.

14. The display controller of claim 13, wherein the reflectivity estimating unit adjusts the chroma differently based on whether or not the chroma is less than a predetermined threshold value.

15. The display controller of claim 12, wherein the illumination light estimating unit estimates the third estimated illumination light by using a Gaussian filter.

16. The display controller of claim 12, further comprising:
a color space conversion unit that converts the input image signal into the brightness value and the color value based on a CIELAB color space;
a contrast adjustment unit that calculates a second estimated illumination light estimated based on a brightness value of an input image signal, wherein the second estimated illumination light is brighter than the first estimated illumination light by a predetermined amount when the brightness of the first estimated illumination light is equal to or less than a predetermined brightness, and that generates a new brightness value based on the first and second estimated illumination lights and the brightness value of the input image signal; and
an output image signal generating unit that generates an output image signal for displaying an image on the transparent display device from the new brightness value and the new color value.

17. The display controller of claim 16, wherein the contrast adjustment unit comprises:
an illumination light estimating unit that executes a vignetting process on the brightness value of the input image signal to estimate the first estimated illumination light;
an adjustment unit that that adjusts brightness of the first estimated illumination light to calculate the second estimated illumination light; and
a reflectivity estimating unit that generates the new brightness value based on the first and second estimated illumination lights and the brightness value of the input image signal.
